(19) United States
(12) Patent Application Publication
(10) Pub. No.: US 2025/0308826 A1
(43) Pub. Date: Oct. 2, 2025

(54) CONTROL UNIT FOR AN ELECTRICAL CIRCUIT BREAKER AND ASSOCIATED ELECTRICAL CIRCUIT BREAKER

(71) Applicant: Schneider Electric Industries SAS, Rueil-Malmaison (FR)

(72) Inventors: Thomas Bianchi, Grenoble (FR); Patrick Prieur, Claix (FR); Yves Leveque, Voiron (FR)

(73) Assignee: Schneider Electric Industries SAS, Rueil-Malmaison (FR)

(21) Appl. No.: 19/091,969

(22) Filed: Mar. 27, 2025

(30) Foreign Application Priority Data
Mar. 28, 2024 (FR) 2403192

(51) Int. Cl. H01H 71/02

(52) U.S. Cl. CPC H01H 71/0228

(57) ABSTRACT

This control unit (20) comprises a casing (30) comprising a rear sub-assembly (34) and a front sub-assembly (100), which is assembled to the rear sub-assembly, and which comprises a central portion (102) with two opposing transverse edges (111, 112). The front sub-assembly (100) also comprises fastening members (121, 122) while the rear sub-assembly (34) comprises complementary members (131, 132), which are configured to cooperate with the fastening members to secure the front sub-assembly (100) to the rear sub-assembly (34), so that the two transverse edges are blocked in translation relative to the rear sub-assembly (34) according to two respective opposite and divergent directions, while each of the transverse edges is free to rotate relative to the rear sub-assembly (34) around an axis parallel to the considered transverse edge.

This invention relates to a control unit for an electrical circuit breaker, as well as a circuit breaker comprising such a control unit.

Electrical circuit breakers including a breaker unit and an electronic control unit are known in particular from EP-0 843 332-A1. Such a control unit is typically configured to measure in real-time the operating state of the circuit breaker and to command the opening of the breaker unit in case of detecting a malfunction of the circuit breaker. The control unit is reversibly received in a receptacle provided in the breaker unit and is located on a frontal face of the circuit breaker, so that a user can read and/or adjust certain operating parameters of the electrical circuit breaker. The control unit is removable, in such a way that a user can replace the control unit in case of malfunction, without having to disconnect the breaker unit from the rest of the electrical installation.

With the evolution of technologies and needs, it is advantageous to offer the user an operational interface, also known as a “human machine interface” or HMI, which allows the user to easily understand an operating state of the control unit and/or make adjustments to the control unit. Thus, according to the case, the HMI of the control unit comprises one or more elements chosen, not limiting, from one or more indicator lights and/or one or more buttons and/or a display screen. These HMI elements are gathered on a front sub-assembly of the control unit, the front sub-assembly being fixed to a rear sub-assembly to form a casing of the control unit.

However, these HMI elements—particularly the screen—are relatively fragile compared to the rest of the control unit. During the triggering of the circuit breaker, various electrical and/or magnetic and/or mechanical phenomena generate a breaking shock, which may damage or eject the HMI elements.

EP 3 290 935-A1 describes, for example, a control unit comprising a front sub-assembly, which comprises a central portion on which several human machine interface elements are arranged. The front sub-assembly is fixed, by clipping, to a casing of the control unit. This front sub-assembly tends to be ejected from the housing by the breaking shock wave during triggering of the circuit breaker, which is unsatisfactory.

The traditional approach to prevent the ejection of the front sub-assembly consists of adding fastening elements such as screws, to secure the front sub-assembly to the rear sub-assembly. However, screws create hard points, which increase local stresses during triggering, risking cracking the front sub-assembly. This approach is not satisfactory.

This invention aims to address these problems by proposing a control unit for an electrical circuit breaker comprising a front sub-assembly, the front sub-assembly comprising a central portion with at least one HMI element, in which the front sub-assembly is resistant to breaking shocks.

To this end, the invention relates to a control unit for an electrical circuit breaker, the control unit being configured to be received in a receptacle opening onto a frontal face of a breaker unit of the circuit breaker so as to control the breaker unit, in which:
the control unit presents a front face, which presents a generally flat shape and is geometrically carried by a front plane, the front plane being orthogonal to a depth axis and defining a forward direction oriented toward the user when the control unit is in a normal use configuration, the front plane being parallel to a height axis and a transverse axis of the control unit,
the control unit comprises a casing, which is made of an electrically insulating material, the housing comprising a rear sub-assembly and a front sub-assembly, which is assembled to the rear sub-assembly, and which comprises a central portion which forms a portion of the front face of the control unit, the central portion being configured to receive at least one human machine interface element,
the central portion comprises two transverse edges, which include a first edge and a second edge, which are located on either side of the central portion and extend parallel to each other and parallel to the transverse axis,
the front sub-assembly also includes fastening members of the front sub-assembly to the rear sub-assembly, the fastening members including a first fastening member, which is located near the first edge, and a second fastening member, which is located near the second edge,
the rear sub-assembly is made of an insulating material and comprises complementary members, which are configured to cooperate with the fastening members of the front sub-assembly, so as to secure the front sub-assembly to the rear sub-assembly in an assembled position of the front sub-assembly to the rear sub-assembly, where a front side of the central portion is oriented according to the forward direction and forms a portion of the front face of the control unit,
   wherein:
the complementary members include a first complementary member, which cooperates with the first fastening member so as to form a first kinematic link between the front sub-assembly and the rear sub-assembly, the first kinematic link being such that:
   the first edge is blocked in translation relative to the rear sub-assembly according to a first direction parallel to the height axis, and
   the first edge is free in rotation relative to the rear sub-assembly around a first axis parallel to the transverse axis,
the complementary members include, in addition to the first complementary member, a second complementary member, which cooperates with the second fastening member so as to form a second kinematic link between the front sub-assembly and the rear sub-assembly, the second kinematic link being such that:
   the second edge is blocked in translation relative to the rear sub-assembly in a second direction opposite to the first direction, and
   the second edge is free in rotation relative to the rear sub-assembly around a second axis parallel to the transverse axis.

Thanks to the invention, the front sub-assembly is held, along the two transverse edges, by kinematic links blocking translation but allowing rotation. In other words, the central portion is free to elastically deform by bending. During a triggering of the breaker unit, the deformations caused by the breaking shock are thus distributed and absorbed over the entire front sub-assembly. The absence of hard points means that the front sub-assembly bends but does not break.

According to advantageous but non-mandatory aspects of the invention, such a control unit may incorporate one or more of the following features taken individually or in any technically permissible combination:
The first fastening member comprises at least one hook, which is arranged recessed from the central portion according to the forward direction, each hook comprising a curved end that extends according to the same direction parallel to the height axis and which forms a recess, the recess of each hook being geometrically carried by the same axis parallel to the transverse axis,
whereas the first complementary member includes at least one cavity, each cavity being provided, recessed in the rear sub-assembly and being configured to receive a respective hook in an engaged configuration of the hook, each cavity opening toward the front of the rear sub-assembly by a respective hole and providing an internal support face, which is oriented toward the inside of the corresponding cavity according to a rearward direction, opposite to the forward direction,
and whereas, when each hook is in an engaged configuration, the curved end cooperates with the corresponding internal support face, so as to form the first kinematic link, the first axis being substantially aligned with the recess of each hook.
Each hook comprises a lug, which is provided in projection, relative to the curved end portion of the considered hook, in the recess of the considered curved end portion, whereas each internal support face comprises a complementary recess, which is configured to receive the lug of the corresponding hook, so as to prevent movements in translation parallel to the height axis of the hook relative to the corresponding internal support face, when the hook is in an engaged configuration.
The front sub-assembly comprises clipping members, which are located at a distance from the first edge, and which are configured to cooperate with complementary clipping members of the rear sub-assembly, so as to hold the front sub-assembly in the assembled position when each hook is in an engaged configuration.
The second fastening member includes a protrusion, which extends in projection relative to the central portion and is recessed from the central portion, the protrusion providing a support surface, oriented toward the front when the front sub-assembly is in the assembled position to the rear sub-assembly,
whereas the control unit also comprises a lock, which forms the second complementary member, the lock being assembled to the casing and being movable relative to the casing between a locking position and a release position,
whereas the lock comprises a locking face, which is located facing the support surface, according to the forward direction, when the lock is in the locking position, so as to prevent movements in translation of the protrusion relative to the rear sub-assembly according to the forward direction, thus preventing movements in rotation of the front sub-assembly relative to the rear sub-assembly around the first axis,
and whereas, when the lock is in the release position, the lock does not prevent movements in translation of the protrusion relative to the rear sub-assembly in the forward direction, thus allowing movements in rotation of the front sub-assembly relative to the rear sub-assembly around the first axis.
The lock is pivotably mounted relative to the rear sub-assembly around a lock axis parallel to the transverse axis, the locking position and the release position being two angular positions of the lock relative to the rear sub-assembly around the lock axis.
   The invention also relates to an electrical circuit breaker, comprising:
a breaker unit, comprising at least one breaker device and an actuator,
one example of the control unit such as described above,
   wherein:
the breaker unit provides a receptacle, which opens onto the frontal face of the breaker unit,
the control unit is received in the receptacle of the breaker unit, so that the front face of the control unit is substantially aligned with the frontal face of the breaker unit.

### Advantageously:

the second transverse edge of the front sub-assembly is located at the edge of the front face of the control unit,
the control unit is as described above,
the lock presents a recess, which is located, recessed from the front face when the lock is in the locking position, the recess presents a blocking face, which is oriented according to a direction, orthoradial to the lock axis,
the circuit breaker comprises a cover, which is configured to be assembled to the breaker unit, so as to form a portion of the frontal face of the breaker unit, the cover presents a window, through which the front face of the control unit is visible,
the window comprises a blocking edge, which cooperates with the blocking face so as to hold the lock in the locking position when the control unit is received in the receptacle and that the cover is assembled to the breaker unit.

The invention will be better understood, and other advantages thereof will appear more clearly in light of the following description of one embodiment of a control unit and an electrical circuit breaker, in accordance with its principle, given solely by way of example and made with reference to the appended drawings, in which:

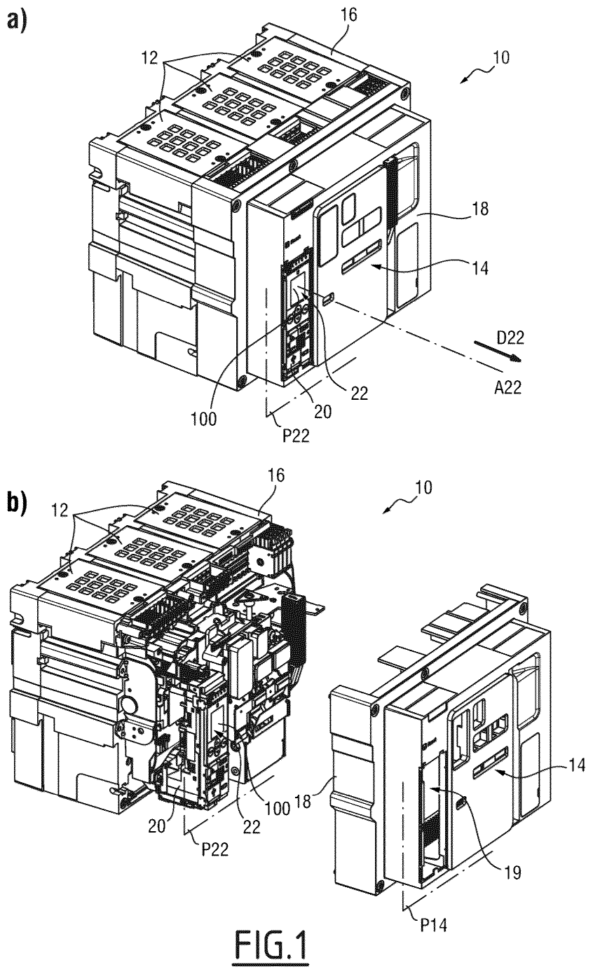

FIG. 1 respectively represents, in two inserts a) and b), a perspective view and a partially exploded perspective view of an electrical circuit breaker in accordance with the invention, the electrical circuit breaker comprising a control unit, also in accordance with the invention;

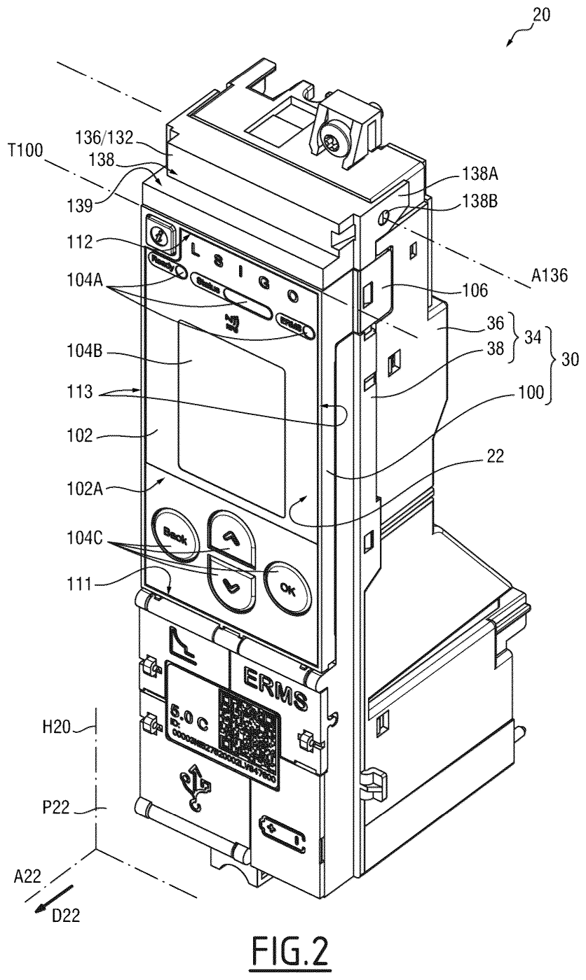

FIG. 2 is a perspective view of the control unit of FIG. 1, the control unit comprising a casing, a front sub-assembly, and a lock, the lock being in a locking configuration;

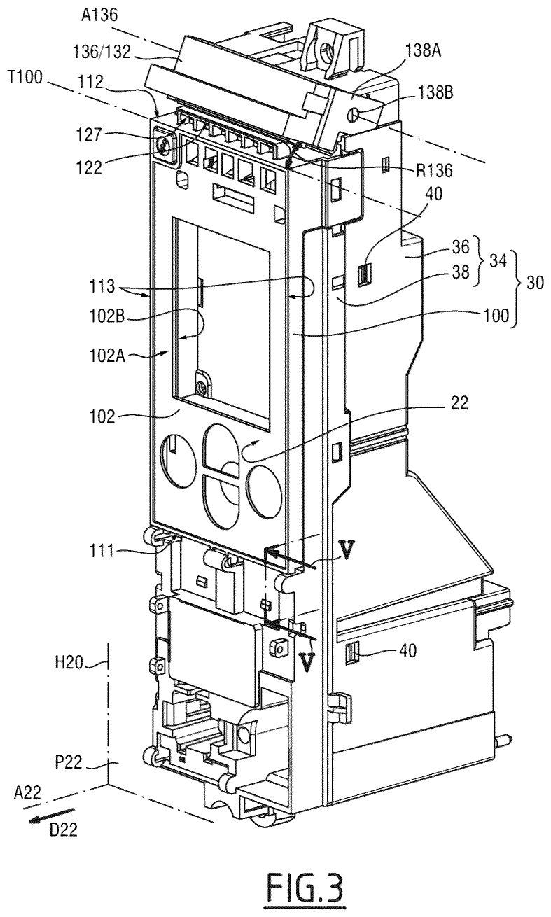

FIG. 3 is a perspective view of the casing, the front sub-assembly, and the lock of the control unit of FIG. 2, the lock being in a release configuration;

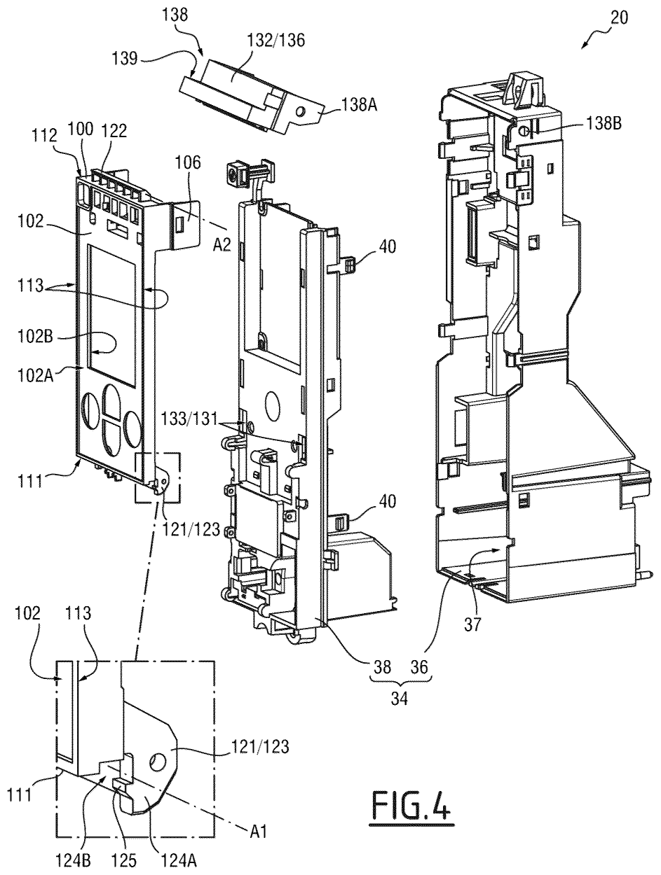

FIG. 4 is an exploded perspective view of the casing, the front sub-assembly, and the lock of the control unit of FIG. 2;

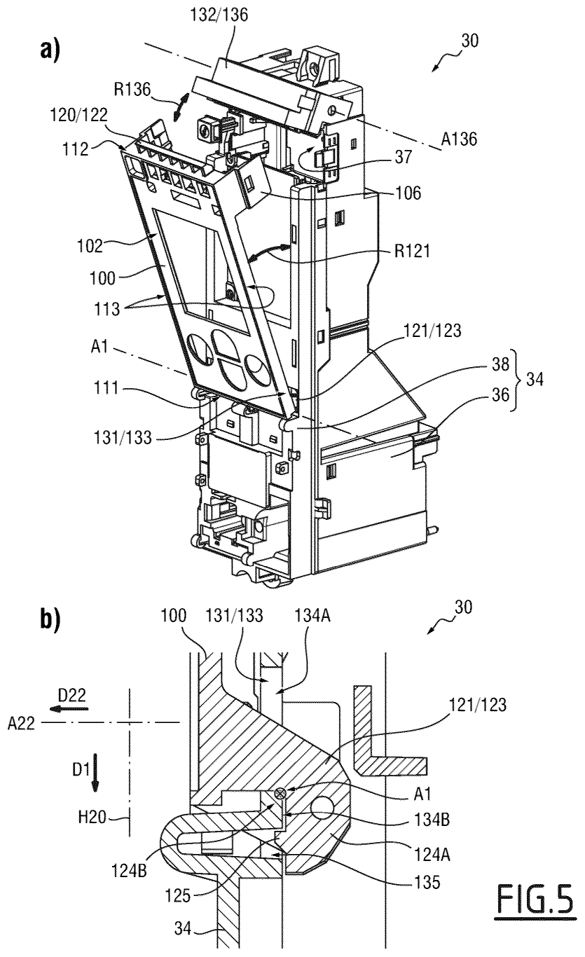

FIG. 5 represents, in two inserts a) and b), a perspective view of the control unit of FIG. 3 in an intermediate configuration during the assembly of the control unit, and a cross-section according to a plane V-V of a detail of the control unit of FIG. 3;

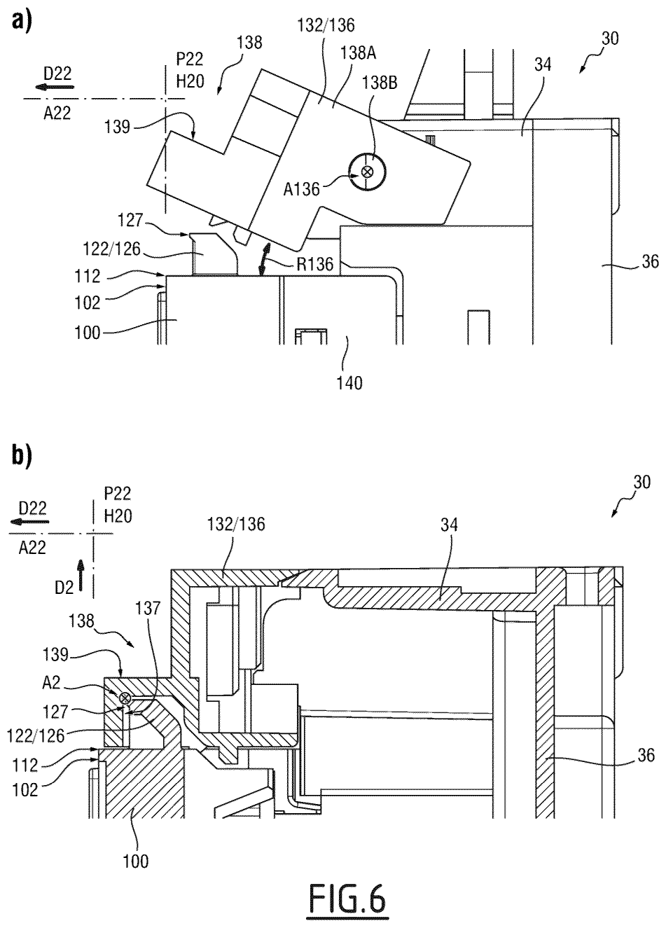

FIG. 6 represents, in two inserts a) and b), a side view of the control unit of FIG. 3, the lock being in a release position, and a cross-section of a detail of the control unit of FIG. 3, the lock being in a locking position;

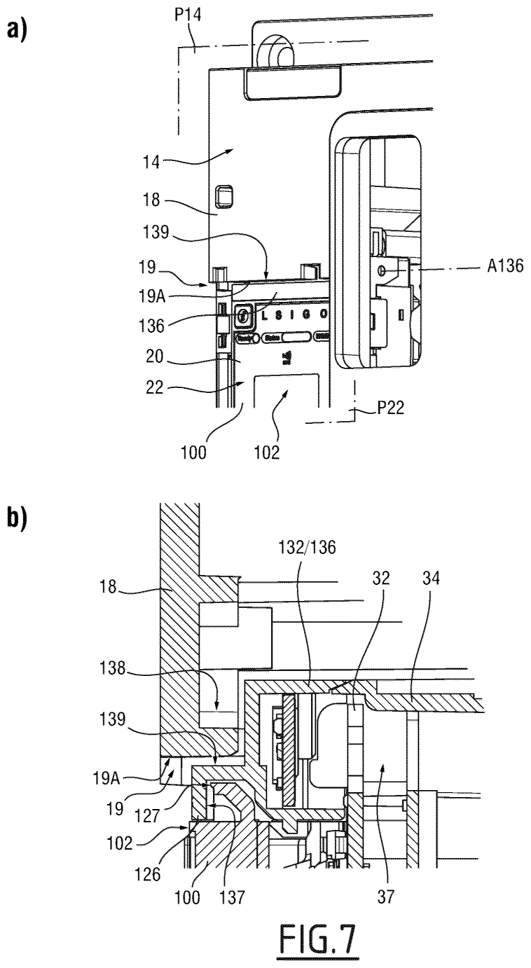

FIG. 7 respectively represents, in two inserts a) and b), a perspective view and a section of the electrical circuit breaker of FIG. 1, some parts being hidden.

An electrical circuit breaker 10 is represented in FIG. 1. The electrical circuit breaker 10, also simply called circuit breaker 10, is here a multipolar circuit breaker, in particular a tripolar circuit breaker. The number of poles of the circuit breaker 10 is not limiting. As is known, a multipolar electrical circuit breaker includes, for each electrical pole, input and output power terminals, which are respectively connected or electrically isolated from each other by a breaker device of the circuit breaker. The breaker device comprises, for example, separable movable contacts, which are received in a breaker chamber of the electrical circuit breaker 10 and the movements of which are controlled by an actuator. Thus, the breaker device can be triggered by the actuator. The breaker chambers are here materialized by three grids 12 visible on an upper face of the circuit breaker 10, the other elements of the breaker device not being represented.

The electrical circuit breaker 10 is intended to be used within an electrical installation, for example, to control the power supply of a machine tool. In a normal use configuration, the electrical circuit breaker 10 is generally placed within an electrical cabinet, the electrical circuit breaker 10 presents a frontal face 14, which is oriented toward the user standing in front of the electrical cabinet. The electrical cabinet is not represented.

The electrical circuit breaker 10 comprises a breaker unit 16, which includes, in particular, each of the breaker chambers, as well as the breaker device and the associated actuator.

The electrical circuit breaker 10 advantageously comprises a cover 18, which is reversibly fixed to the breaker unit 16. The cover 18 is made of an electrically insulating material and extends generally according to a frontal plane P14, which defines a portion of the frontal face 14 of the electrical circuit breaker 10, and by extension of the breaker unit 16. The cover 18 thus serves to protect the user of the circuit breaker 10. In FIG. 1 a), the cover 18 is represented assembled to the breaker unit 16, which corresponds to a normal use configuration of the circuit breaker 10. In FIG. 1 b), the cover 18 is spaced away from the breaker unit 16, this configuration being found, for example, during maintenance of the breaker unit 16.

The electrical circuit breaker 10 also comprises a control unit 20. The control unit 20 is configured to analyse the states of the breaker unit 16 and is configured to trigger the actuator based on the results of these analyses, thus separating the separable contacts.

The control unit 20 comprises a front face 22. The front face 22 presents a generally flat shape and is geometrically carried by a front plane P22, which is orthogonal to a depth axis A22 of the control unit 20. The front face 22 is oriented toward the user when the control unit 20 is in a normal use configuration. The front face 22 thus defines a forward direction D22, which is parallel to the depth axis A22. The forward direction D22 is represented by an arrow. The notions of directions such as “front”, “rear”, “top”, “bottom”, etc., are defined in relation to the elements as shown in the drawings, knowing that it may be otherwise in reality.

The cover 18 comprises a window 19, through which the front face 22 of the breaker unit 20 is visible in the forward direction D22. The window 19 is advantageously closed by a transparent flap. The flap is not represented.

The control unit 20 is assembled to the breaker unit 16 in a reversible manner. In the example of FIGS. 1 a) and 1 b), the control unit 20 is represented in an assembled configuration to the breaker unit 16. The control unit 20 is represented separately in FIG. 2.

The breaker unit 16 provides a receptacle, which opens onto a frontal face 14 of the breaker unit 16 and in which the control unit 20 is received, so that the front face 22 of the control unit 20 is substantially aligned with the frontal face 14 of the breaker unit 16, as notably illustrated in FIG. 1 a). The receptacle is not represented.

The control unit 20 is now described. The control unit 20 comprises a casing 30, which is made of an insulating material and forms a receiving volume for various components of the control unit 20. The casing 30 houses, in particular, a printed circuit board 32, which is partially visible in FIG. 7. The printed circuit board 32 includes a printed circuit and several electronic components such as a microprocessor, etc.

The casing 30 comprises a rear sub-assembly 34 and a front sub-assembly 100, the front sub-assembly 100 being assembled to the rear sub-assembly 34 during the manufacture of the control unit 20. The elements of the casing 30 are represented assembled in FIG. 3 and at a distance from each other in FIG. 4. The rear sub-assembly 34 here comprises a rear block 36 and an intermediate wall 38. The rear block delimits a cavity 37, which is closed by the intermediate wall 38 and in which the printed circuit board 32 is received. The intermediate wall 38 is advantageously fixed to the rear block 36 by means of fastening members 40, preferably clipping members, as illustrated in FIG. 4. Alternatively, the rear block 36 and the intermediate wall 38 are manufactured as a single piece. It is understood that when the control unit 20 and the electrical circuit breaker 10 are in a normal use configuration, the front sub-assembly 100 is assembled to the rear sub-assembly 34 so as to close the cavity 37 in which the printed circuit board 32 is received, or more generally an electrical element of the control unit 20, so as to protect users.

The front sub-assembly 100 comprises a central portion 102, which forms a portion of the front face 22 of the control unit 120. The central portion 102 is generally flat and presents a front side 102A and a rear side 102B opposite the front side 102A. The central portion 102 is here configured to receive at least one human machine interface element 104. The front side 102A of the central portion 102 is preferably oriented according to the forward direction D22. A human machine interface is also referred to by its acronym HMI. The human machine interface elements 104 are also simply noted as “HMI elements” 104. In the illustrated example, the central portion 102 comprises several HMI elements 104. The HMI elements 104 here include three indicator lights 104A, a transparent portion 104B, through which a screen can be observed, and four buttons 104C. These examples are not limiting, the type, number, and arrangement of the HMI elements 104 can be changed during the design of the front sub-assembly 100.

Advantageously, the front sub-assembly 100 is assembled to the rear sub-assembly 34 in a reversible manner. It is thus possible to replace the front sub-assembly 100 in case of malfunction.

The central portion 102 here presents a substantially rectangular shape and provides two transverse edges, which include a first edge 111 and a second edge 112, which are located on either side of the central portion 102 and extend parallel to each other. The first edge 111 and the second edge 112 are parallel to a transverse axis T100 of the front sub-assembly 100. The first transverse edge 111 is a lower edge of the central portion 102, while the second transverse edge 112 is an upper edge of the central portion 102, as in the illustrated example. Thus, the first edge 111 is located below the second edge 112 when the control unit 20 is in a normal use configuration. The transverse axis T100 is an axis orthogonal to a height axis H20 of the control unit. By extension, the transverse axis 100 is also a transverse axis for the control unit 20. The front plane P22 is thus parallel to the height axis H20 and the transverse axis T100. The depth axis A22, the height axis H20, and the transverse axis T100 together form an orthogonal reference frame. The height axis H20 is vertical when the control unit 20 is in a normal use configuration. Other arrangements are of course possible.

The central portion 102 also comprises two lateral edges 113, which are parallel to each other, and each connect the first edge 111 to the second edge 112. Thus, the first edge 111, the second edge 112, and the two lateral edges 113 delimit the central portion 102.

The front sub-assembly 100 comprises fastening members 120 of the front sub-assembly 100 to the rest of the control unit 20, in particular to the rear sub-assembly 34. The fastening members 120 include a first fastening member 121, which is located near the first edge 111, and a second fastening member 122, which is located near the second edge 112.

The rear sub-assembly 34 comprises complementary members, which are configured to cooperate with the fastening members 120 of the front sub-assembly 100, so as to secure the front sub-assembly 100 to the rear sub-assembly 34 in an assembled position of the front sub-assembly 100 to the rear sub-assembly 34, thus forming the casing 30 of the control unit 20. The casing 30, and by extension the control unit 20, is then in an assembled configuration, where the front side 102A of the central portion 102 is oriented according to the forward direction D22 and forms a portion of the front face 22 of the control unit 20.

The complementary members include a first complementary member 131, which cooperates with the first fastening member 121 so as to form a first kinematic link between the front sub-assembly 100 and the rear sub-assembly 34, the first kinematic link being such that:
the first edge 101 is blocked in translation relative to the rear sub-assembly according to a first direction D1, which is parallel to the height axis H20,
the first edge 101 is free in rotation relative to the rear sub-assembly 34 around a first axis A1 parallel to the transverse axis T100.

Preferably, the first edge 101 is blocked in translation relative to the rear sub-assembly 34 according to the forward direction D22. In the illustrated example, the first fastening member 121 comprises a hook 123, which is arranged recessed from the central portion 102 according to the forward direction D22. The front sub-assembly 100 here comprises two hooks 123, which are arranged near the junctions between the first edge 111 and the lateral edges 113.

Referring to FIG. 4, each hook 123 here comprises a curved end 124A, which extends according to the same direction parallel to the height axis H20, the curved end 124A delimiting a recess 124B, the recesses 124B of each hook 123 being geometrically carried by a first axis A1, which is parallel to the transverse axis T100. Schematically, the first axis A1 is substantially aligned with the recess 124B of each hook 123.

The first complementary member 131 includes at least one cavity 133, each cavity 133 being provided, recessed in the rear sub-assembly 34 and being configured to receive a respective hook 123 in an engaged configuration of the hook 123. The cavities 133 are here provided in the intermediate wall 38. Each cavity 133 opens toward the front of the rear sub-assembly 34 by a respective hole 134A and provides an internal support face 134B, which is oriented toward the inside of the cavity 133 according to a rearward direction, opposite to the forward direction D22.

When each hook 123 is received in the corresponding cavity 133, the curved end 124A of each hook 123 cooperates with the corresponding internal support face 134B, in particular, by complementarity of shapes, so as to prevent the movements in translation of the hook 123 relative to the support surface 134B parallel to the height axis H20 and downward toward the bottom, while allowing the movements in rotation around the first axis A1. The first direction D1 is oriented from the second edge 112 toward the first edge 111, that is, here oriented downward toward the bottom. The movement in rotation is illustrated by a double-curved arrow R121 in FIG. 5. In other words, the curved end 124A of each hook 123 cooperates with the corresponding internal support face 134B, so as to form the first kinematic link. It is also understood that when the hooks 123 are received in the corresponding cavities 133, the movements in translation of the front sub-assembly 110 relative to the rear sub-assembly 34 parallel to the first axis A1 are prevented.

Advantageously, each hook 123 comprises a lug 125, which is provided in projection, relative to the curved end portion 124A of the considered hook, in the recess 124B of the considered end portion 124A, while each internal support face 134B comprises a complementary recess 135, which is configured to receive the lug 125 of the corresponding hook 123, so as to prevent parallel to the height axis H120 of the hook 123 relative to the corresponding internal support face 134B, when the hook is in an engaged configuration.

The complementary members include, in addition to the first complementary member 131, a second complementary member 132, which cooperates with the second fastening member 122 so as to form a second kinematic link between the front sub-assembly 100 and the rear sub-assembly 34, the second kinematic link being such that:
the second edge 112 is blocked in translation relative to the rear sub-assembly 34 according to a second direction D2 parallel to the height axis H20, the second direction D2 being opposite to the first direction D1, and
the second edge 112 is free in rotation relative to the rear sub-assembly 34 around a second axis A2 parallel to the transverse axis T100.

Preferably, the second edge 112 is blocked in translation relative to the rear sub-assembly 34 in the forward direction D22. In the illustrated example, the second fastening member 122 comprises a protrusion 126, which extends in projection relative to the central portion 102. The protrusion 126 is located recessed from the central portion 102 and extends here toward the top of the control unit, the protrusion 126 providing a support surface 127, which is oriented according to the forward direction D22 when the front sub-assembly 100 is in the assembled position to the rear sub-assembly 34. The support surface 127 here presents an elongated shape that extends parallel to the second edge 112, in other words, parallel to the transverse axis T100.

The control unit 20 comprises a lock 136, which is a separate piece from the casing 30 and forms the second complementary member 132. The lock 136 is movable relative to the casing 30 between a locking position, in which the lock 136 is assembled to the casing 30 and cooperates with the protrusion 126 so as to prevent a movement in translation of the protrusion 126 relative to the rear sub-assembly 34 according to the forward direction D22, and a release position, in which the lock 136 does not prevent a movement in translation of the protrusion 126 relative to the rear sub-assembly 34 according to the forward direction D22. In the illustrated example, the lock 136 comprises a locking face 137, which is located facing the support surface 127, according to the forward direction D22, when the lock 136 is in the locking position.

When the lock 136 is in the release position and each hook 123 is received in the corresponding cavity 133, the lock 136 does not prevent the movements in translation of the protrusion 126 relative to the rear sub-assembly 34 according to the forward direction D22, thus allowing the movements in rotation R121 of the front sub-assembly 100 relative to the rear sub-assembly 34 around the first axis A1.

In a schematic manner, when the lock 136 is in the locking position and each hook 123 is received in the corresponding cavity 133, during a breaking shock, a contact between the support surface 127 and the locking face 137 is comparable to a rectilinear contact, the second axis A2 being geometrically carried by the support surface 127. Thus, a movement in rotation of the front sub-assembly 100 relative to the rear sub-assembly 34, around the second axis A2, is not prevented.

The first direction D1 is oriented from the second edge 112 toward the first edge 111, that is, here oriented downward toward the bottom. Consequently, the second direction D2 is oriented from the first edge 111 toward the second edge 112, that is, here upward toward the top. It is understood that the movements in translation of the front sub-assembly 100 parallel to the height axis H20 are thus generally prevented but, that the first edge 111 and the second edge 112 can approach each other.

In other words, the front sub-assembly 100, although secured to the rear sub-assembly 34, is free to elastically deform by bending. In particular, the central portion 102 is free to elastically deform by bending. During a triggering of the breaker unit 15, the deformations caused by the breaking shock are thus distributed and absorbed over the entire front sub-assembly 100, and, in particular, over the central portion 102. The absence of hard points reduces the risk of cracking, in other words, the front sub-assembly 100 bends but does not break. The front sub-assembly 100 then returns to its initial position by elastic return.

Advantageously, the front sub-assembly 100 comprises clipping members 106, which are located at a distance from the first edge 111 and which are configured to cooperate with complementary clipping members of the rear sub-assembly 34, so as to hold the front sub-assembly 100 in the assembled position when each hook 123 is received in the corresponding cavity 133. The role of the clipping members 106 is mainly to retain the front sub-assembly 100 when the lock 136 is in the release position rather than to retain the front sub-assembly 100 during a triggering. The clipping members 106 are preferably located near the second edge 112, so as not to hinder the bending of the central portion 102 of the front sub-assembly 100.

Advantageously, the lock 136 is pivotably mounted relative to the rear sub-assembly 34 around a lock axis A136 parallel to the second edge 112, the locking position and the release position being two angular positions of the lock 136 relative to the rear sub-assembly 34 around the lock axis A136. To this end, the lock 136 here comprises the clipping members 138A, which cooperate with the pins 138B provided on the rear sub-assembly 34. A movement in rotation R136 of the lock 136 relative to the rear sub-assembly 34 between the locking position and the release position is represented by a double arrow in the figures. The transition from the locking position to the release position is advantageously done by hand, and without tools.

Advantageously, the second transverse edge 112 of the front sub-assembly 100 is located at the edge of the front face 22 of the control unit 20. The lock 136 presents a recess 138, which is located recessed from the front face 22 when the lock 136 is in the locking position, the recess 138 providing a blocking face 139. The blocking face 139 is oriented according to an axis, orthoradial to the lock axis A136, in other words, according to an axis that is orthogonal to a plane passing through the lock axis A136 but does not cut the lock axis A136. In other words, when the blocking face 139 is blocked, then the movement in rotation R136 of the lock 136 is prevented. The blocking face 139 is preferably oriented toward the top of the control unit 20, that is, here according to the second direction D2.

The window 19, provided in the cover 18, comprises a blocking edge 19A, which is located facing the blocking face 139 when the control unit 20 is received in the receptacle and the cover 28 is assembled to the breaker unit 16. The blocking edge 19A cooperates with the blocking face 139 to hold the lock 136 in the locking position.

The embodiments and alternatives mentioned above can be combined with each other to generate new embodiments of the invention.

1. A control unit for an electrical circuit breaker, the control unit being configured to be received in a receptacle opening onto a frontal face of a breaker unit of the circuit breaker so as to control the breaker unit, wherein:
the control unit presents a front face, which presents a generally flat shape and is geometrically carried by a front plane, the front plane being orthogonal to a depth axis and defining a forward direction oriented toward the user when the control unit is in a normal use configuration, the front plane being parallel to a height axis and a transverse axis of the control unit,
the control unit comprises a casing, made of an electrically insulating material, the casing comprises a rear sub-assembly and a front sub-assembly, which is assembled to the rear sub-assembly, and which comprises a central portion forming a portion of the front face of the control unit,
the central portion includes two transverse edges, which comprise a first edge and a second edge, which are located on either side of the central portion and which extend parallel to each other and parallel to the transverse axis,
the front sub-assembly also comprises fastening members to secure the front sub-assembly to the rear sub-assembly, the fastening elements including a first fastening member, which is located near the first edge, and a second fastening member, which is located near the second edge,
the rear sub-assembly is made of an insulating material and comprises complementary members, which are configured to cooperate with the fastening members of the front sub-assembly, so as to secure the front sub-assembly to the rear sub-assembly in an assembled position of the front sub-assembly to the rear sub-assembly, where a front side of the central portion is oriented according to the forward direction and forms a portion of the front face of the control unit,
wherein:
the complementary members include a first complementary member, which cooperates with the first fastening member to form a first kinematic link between the front sub-assembly and the rear sub-assembly, the first kinematic link being such that:
the first edge is blocked in translation relative to the rear sub-assembly according to a first direction parallel to the height axis, and
the first edge is free in rotation relative to the rear sub-assembly around a first axis parallel to the transverse axis,
the complementary members include, in addition to the first complementary member, a second complementary member, which cooperates with the second fastening member so as to form a second kinematic link between the front sub-assembly and the rear sub-assembly, the second kinematic link being such that:
the second edge is blocked in translation relative to the rear sub-assembly according to a second direction opposite to the first direction, and
the second edge is free in rotation relative to the rear sub-assembly around a second axis parallel to the transverse axis.

2. The control unit according to claim 1, wherein:
the first fastening member comprises at least one hook, arranged recessed from the central portion according to the forward direction, each hook comprises a curved end extending according to the same direction parallel to the height axis and which forms a recess, the recess of each hook being geometrically carried by the same axis parallel to the transverse axis,
the first complementary member includes at least one cavity, each cavity being recessed in the rear sub-assembly and configured to receive a respective hook in an engaged configuration of the hook, each cavity opening toward the front of the rear sub-assembly by a respective hole and providing an internal support face, which is oriented toward the inside of the corresponding cavity according to a rearward direction, opposite to the forward direction,
when each hook is in an engaged configuration, the curved end cooperates with the corresponding internal support face, so as to form the first kinematic link, the first axis being substantially aligned with the recess of each hook.

3. The control unit according to claim 2, wherein:
each hook comprises a lug, which is provided in projection, relative to the curved end portion of the considered hook, in the recess of the curved end portion,
each internal support face comprises a complementary recess, configured to receive the lug of the corresponding hook, so as to prevent the movements in translation, parallel to the height axis, of the hook relative to the corresponding internal support face, when the hook is in an engaged configuration.

4. The control unit according to claim 2, wherein:
the front sub-assembly comprises clipping members, which are located at a distance from the first edge, and which are configured to cooperate with complementary clipping members of the rear sub-assembly, so as to hold the front sub-assembly in the assembled position when each hook is in an engaged configuration.

5. The control unit according to claim 2, wherein:
the second fastening member comprises a protrusion, which extends in projection relative to the central portion and is recessed from the central portion, the protrusion providing a support surface oriented toward the front when the front sub-assembly is in the assembled position to the rear sub-assembly,
the control unit also comprises a lock, which forms the second complementary member, the lock being assembled to the casing and being movable relative to the casing between a locking position and a release position,
the lock comprises a locking face, which is located facing the support surface, in the forward direction, when the lock is in the locking position, so as to prevent the movements in translation of the protrusion relative to the rear sub-assembly in the forward direction, thus preventing the movements in rotation of the front sub-assembly relative to the rear sub-assembly around the first axis,
when the lock is in the release position, the lock does not prevent the movements in translation of the protrusion relative to the rear sub-assembly according to the forward direction, thus allowing the movements in rotation of the front sub-assembly relative to the rear sub-assembly around the first axis.

6. The control unit according to claim 5, wherein:
the lock is pivotably mounted relative to the rear sub-assembly around a lock axis parallel to the transverse axis, the locking position and the release position being two angular positions of the lock relative to the rear sub-assembly around the lock axis.

7. An electrical circuit breaker, comprising:
the breaker unit, comprising at least one breaker device and an actuator,
one example of the control unit according to claim 1,
wherein:
the breaker unit provides a receptacle, which opens onto the frontal face of the breaker unit,
the control unit is received in the receptacle of the breaker unit, so that the front face of the control unit is substantially aligned with the frontal face of the breaker unit.

8. The electrical circuit breaker according to claim 7, wherein:
the second transverse edge of the front sub-assembly is located at the edge of the front face of the control unit,
the first fastening member comprises at least one hook, arranged recessed from the central portion according to the forward direction, each hook comprises a curved end extending according to the same direction parallel to the height axis and which forms a recess, the recess of each hook being geometrically carried by the same axis parallel to the transverse axis,
the first complementary member includes at least one cavity, each cavity being recessed in the rear sub-assembly and configured to receive a respective hook in an engaged configuration of the hook, each cavity opening toward the front of the rear sub-assembly by a respective hole and providing an internal support face, which is oriented toward the inside of the corresponding cavity according to a rearward direction, opposite to the forward direction,
when each hook is in an engaged configuration, the curved end cooperates with the corresponding internal support face, so as to form the first kinematic link, the first axis being substantially aligned with the recess of each hook,
the second fastening member comprises a protrusion, which extends in projection relative to the central portion and is recessed from the central portion, the protrusion providing a support surface oriented toward the front when the front sub-assembly is in the assembled position to the rear sub-assembly,
the control unit also comprises a lock, which forms the second complementary member, the lock being assembled to the casing and being movable relative to the casing between a locking position and a release position,
the lock comprises a locking face, which is located facing the support surface, in the forward direction, when the lock is in the locking position, so as to prevent the movements in translation of the protrusion relative to the rear sub-assembly in the forward direction, thus preventing the movements in rotation of the front sub-assembly relative to the rear sub-assembly around the first axis,
when the lock is in the release position, the lock does not prevent the movements in translation of the protrusion relative to the rear sub-assembly according to the forward direction, thus allowing the movements in rotation of the front sub-assembly relative to the rear sub-assembly around the first axis,
the lock presents a recess, which is located recessed from the front face when the lock is in the locking position, the recess presenting a blocking face, which is oriented according to a direction, orthoradial to the lock axis,
the circuit breaker comprises a cover, which is configured to be assembled to the breaker unit, so as to form a portion of the frontal face of the breaker unit, the cover presents a window, through which the front face of the control unit is visible,
the window comprises a blocking edge, which cooperates with the blocking face so as to hold the lock in the locking position when the control unit is received in the receptacle and the cover is assembled to the breaker unit.
